(19) United States
(12) Patent Application Publication
(10) Pub. No.: US 2016/0371276 A1
(43) Pub. Date: Dec. 22, 2016

(54) ANSWER SCHEME FOR INFORMATION REQUEST

(71) Applicant: MICROSOFT TECHNOLOGY LICENSING, LLC, Redmond, WA (US)

(72) Inventors: Andre Wilson Brotto Furtado, Kirkland, WA (US); Robert L. Rounthwaite, Fall City, WA (US); Xiaohan Shi, Sammamish, WA (US); Matthew Richardson, Seattlw, WA (US); Ryen White, Woodinville, WA (US); Syed Fahad Allam Shah, Bellevue, WA (US); Shantanu Sharma, New Castle, WA (US)

(21) Appl. No.: 14/744,974

(22) Filed: Jun. 19, 2015

(51) Int. Cl. G06F 17/30

(52) U.S. Cl. CPC G06F 17/3053; G06F 17/30867

(57) ABSTRACT

One or more techniques and/or systems are provided for providing an answer scheme for an information request. For example a requester user may submit an information request seeking an informational answer (e.g., how far is the moon from the Earth; what are fun Cancun activities; is my drawing an accurate octagon; etc.). The information request may be evaluated to identify an information request property (e.g., an interesting property, a factual question property, an opinion property, an expertise level property, etc.). An answerer pool and/or an interaction type may be identified based upon the information request property (e.g., a chat group of scientists, a onetime text message answer from a paid expert, a vacation forum, a screen sharing session, etc.). An answer scheme, comprising the answerer pool and/or the interaction type, may be provided to the requester user for obtaining the informational answer.

### BACKGROUND

Many users may utilize various services to discover, explore, and engage with content such as to complete a task, obtain an opinion, and/or obtain an answer to a question. In an example, a user may submit a search query “what are yummy casserole dish ideas” to a search engine. The search engine may provide the user with search results that are relevant to casserole dishes. In another example, the user may be researching a vacation. The user may post a social network post “Has anyone taken a fun vacation lately, and if so to where?” to a social network. The user may read vacation forums and user vacation reviews in order to identify a vacation spot for an upcoming vacation.

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

Among other things, one or more systems and/or techniques for providing an answer scheme for an information request are provided herein. In an example, an information request seeking an informational answer is received. The information request is evaluated to identify an information request property. An interaction type is selected based upon the information request property. In an example, the interaction type is selected from a ranked set of interaction types (e.g., interaction types ranked based upon the information request property) based upon a first rank of the interaction type. An answerer pool is selected based upon the information request property. In an example, the answerer pool is selected from a ranked set of answerer pools (e.g., answerer pools ranked based upon the information request property) based upon a second rank of the answerer pool. An answer scheme to use for obtaining the informational answer is provided. The answer scheme comprises the interaction type and the answerer pool. In an example, the information request is submitted to an interaction service corresponding to the interaction type and the answerer pool. A requester user is provided with informational answer tracking functionality for the interaction service.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram illustrating an exemplary method of providing an answer scheme for an information request.

FIG. 2 is a component block diagram illustrating an exemplary system for providing an answer scheme for an information request.

FIG. 3 is a component block diagram illustrating an exemplary system for providing an answer scheme for an information request.

FIG. 4 is a component block diagram illustrating an exemplary system for providing an answer scheme and informational answer tracking functionality.

FIG. 5 is a component block diagram illustrating an exemplary system for providing an answer scheme for an information request.

FIG. 6 is a component block diagram illustrating an exemplary system for providing an answer scheme for an information request.

FIG. 7A is a component block diagram illustrating an exemplary system for receiving a user rating for an answer scheme.

FIG. 7B is a component block diagram illustrating an exemplary system for receiving a user rating for an answer scheme.

FIG. 8 is an illustration of an exemplary computer readable medium wherein processor-executable instructions configured to embody one or more of the provisions set forth herein may be comprised.

FIG. 9 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth to provide an understanding of the claimed subject matter. It may be evident, however, that the claimed subject matter may be practiced without these specific details. In other instances, structures and devices are illustrated in block diagram form in order to facilitate describing the claimed subject matter.

One or more systems and/or techniques for providing an answer scheme for an information request are provided herein. The answer scheme may, for example, be thought of as a framework that is provided to a user to assist the user in obtaining an answer to a question. The answer scheme comprises an interaction type (e.g., a group chat, a video call, a text message answer, a forum, etc.) and/or an answerer pool (e.g., an unpaid answerer, a paid answer, a topic expert, a group of opinionated answerers, etc.). The interaction type corresponds, for example, to a type of medium through which a question may be posed, and may comprise communication information used to access such a medium (e.g., a website address of a forum). The answerer pool corresponds, for example, to entities suitable to answer the question, and may comprise communication information used to pose questions to such entities (e.g., a phone number of a user designated as available for providing text message answers to questions). Thus, depending upon the composition of the answer scheme, a user may be provided with an option to send a text message to a paid answerer to obtain an answer to a question, for example.

In an example, a user may desire to obtain information (e.g., from one or more other users, a service, an artificial intelligence content provider, a personal assistant, a website, a social network app, etc.), such as an opinion on how to change a car's oil, a fact about when the Civil War started, an answer to an uninteresting math homework problem, a visual question regarding whether a user created sculpture is a correct representation of a famous sculpture, etc. Unfortunately, the user may not realize what types of interaction services (e.g., a single text message answer, a forum, a helpdesk service, a video chat service, a phone call, a social network post, etc.) and/or what answerer pools (e.g., paid answerers, unpaid answerers, social network entities/friends, experts in a particular field, search experts, etc.) may efficiently lead to desired information. An answerer pool may, for example, comprise information used to access an entity that may be capable of providing an answer to a question. The information may, for example, specify an email address of a human answerer, a link to open a chat interface used to facilitate communication between the user and an answerer, a hyperlink to a forum through which users may ask questions, a phone number of a registered answerer, contact information of a company that provides answers for a charge, and/or any other information that may be used to facilitate obtaining an answer to a question. Manual searching for types of interaction services and/or answerer pools may lead to trial and error, thus resulting in wasted user time and computing resources such as network bandwidth, processing power, interaction service utilization (e.g., server processing resources of a server that hosts an interaction service), battery life, and/or other resources wasted during unsuccessful and/or inefficient attempts to obtain information.

Accordingly, as provided herein, information request properties of the information request may be identified (e.g., an urgency for information; whether a question is interesting enough to appeal to an unpaid answerer or whether the question should be directed towards a paid answerer; whether a single text message can convey an appropriate answer; whether an answerer could provide a better answer having imagery and/or video regarding the question; a level of expertise for answering the question; whether a discussion forum would be helpful in obtaining open ended opinions as the answer; whether the question is open ended or factual; whether the question could use additional clarification; etc.). It may be appreciated that a wide variety of information request properties may be identified by various techniques. For example, text of the information request may be parsed to identify keywords that may be used to determine if similar questions were interesting enough to be answered by particular answerer pools (e.g., whether comparisons of two car companies were exchanged in a forum such that the forum may be a successful candidate for comparing two other car companies). Such keywords may be used to select a particular answerer pool over other answerer pools (e.g., more topically relevant answerer pool, higher ranked answerer pool in a relevant genre, default answerer pool, free answerer pool, etc.). For example, the question may be posed to unpaid answerers first, and then to paid answerers if few to no answers are received from the unpaid answerers.

The information request properties may be used to select an appropriate interaction type (e.g., a group chat, a video call, a text message answer, a forum, etc.) and/or an appropriate answerer pool (e.g., an unpaid answerer, a paid answer, a topic expert, a group of opinionated answerers, a machine answerer such as a personal assistant program or artificial intelligence answerer, a content provider such as a weather provider, a website such as a weather website, a document such as an online weather forecast, multimedia content such as a video weather broadcast, etc.). An answer scheme may be created based upon the interaction type and the answerer pool. The answer scheme may be used by a requester user to efficiently obtain an informational answer for the information request. In this way, computing resources, such as network bandwidth and processing resources of interaction services and/or client devices, may be efficiently utilized by directing the requester user to an interaction service that may efficiently provide the informational answer. Efficiency may also be promoted and/or resources conserved where a search engine provider leverages off of the answer scheme. For example, if a subject is trending (e.g., a number of queries pertaining to frozen water pipes is rapidly increasing), then the search engine provider may be willing to pay professionals to provide information pertaining to the subject (e.g., pay professionals to provide high-quality answers to queries regarding how to unfreeze water pipes). By developing reputable answers at the outset of trending topics, the search engine provider may be included in answer schemes (e.g., answerer pools for respective topics). High-quality answers provided by the search engine provider may thus allow users to quickly and efficiently obtain answers to questions (e.g., the answers can be stored in knowledge bases and reused as part of answer schemes to answer similar questions posed by other users). In an example, an answer scheme component, configured for providing an answer scheme for an information request, may be locally hosted on a client device of the requester user. In another example, the answer scheme component may be hosted remotely from the client device, such as by a server (e.g., a cloud content server, a search engine, etc.). In an example, some of the answer scheme component may be hosted locally while some of the answer scheme component may be hosted remotely.

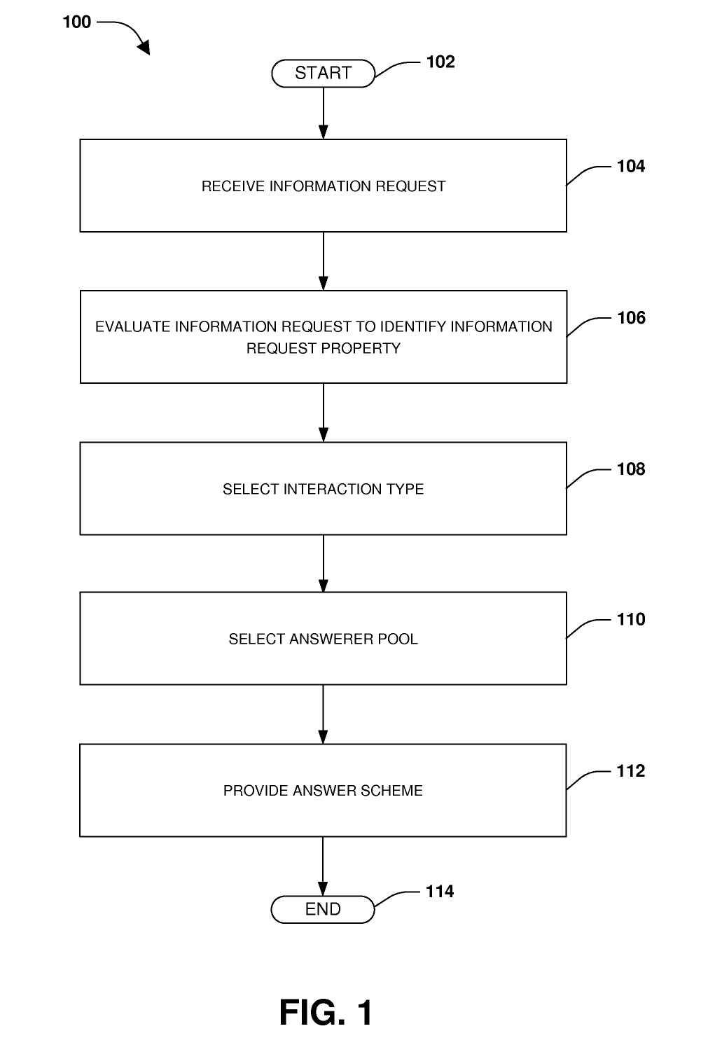

An embodiment of providing an answer scheme for an information request is illustrated by an exemplary method 100 of FIG. 1. At 102, the method starts. At 104, an information request seeking an informational answer (e.g., an answer to a question; an opinion on a topic; a request for information related to the topic; etc.) may be received. For example, a requester user may submit a question “what is the best pizza in Cleveland”. In an example, the information request may be evaluated to determine whether the information request corresponds to a type of question that is supported for being answered by another person or agent (e.g., whether providing an answering scheme for the information request would be useful and/or appropriate), and if not, then the information request may be merely used as a search query submitted to a search engine or answered in another manner, such as through a personal assistant application. At 106, the information request may be evaluated to identify an information request property (e.g., where the information request corresponds to a type of question that is supported and/or appropriate for answering via an answering scheme). The information request property may comprise a factual question property (e.g., how tall is the Empire State building), an interesting property (e.g., a car engine modification question that may be interesting to an automotive expert), an uninteresting property (e.g., a grade school math homework problem that may not be interesting to a math professor volunteer answerer that may otherwise be interested in complex math questions), an open question seeking opinions property (e.g., a favorite vacation spots question), a sensitivity property (e.g., a specific tax question), an urgency property (e.g., taxes might be due in a week from submission of the tax question), a technology property (e.g., a relatively complex technology question, such as how to install a wireless network, that may be better suited to be answered by an answerer that purports to have a requisite knowledge level in a wireless technology field), a visual property (e.g., an answerer may benefit from seeing a video of a broken furnace and/or a photo of a part of the broken furnace that the requester user would like to learn how to repair), a previous unsuccessful attempt for an answer property (e.g., three weeks may have passed without a successful answer), a topic property (e.g., an electrical question that may be better answered by an electrician), an expertise level property (e.g., a user may specify such as through an input interface that a desired answerer has journeyman status or equivalent; the question may be parsed to obtain keywords that may indicate that the question corresponds to a topic (e.g., nuclear physics) assigned to a particular requisite knowledge level that may be used to identify an answerer purporting to have such a requisite knowledge level (e.g., nuclear physicist)), etc. For example, the question “what is the best pizza in Cleveland” may be evaluated to determine an open question seeking opinions property, a low expertise level property (e.g., user opinions by anonymous customers may be acceptable, as well as opinions from food experts/critics), a food topic, and/or other properties.

At 108, an interaction type (e.g., email, text, chat, forum, etc.) may be selected based upon the information request property. In an example, the interaction type is selected from an interaction type catalogue that may comprise a database, a table, a list, etc. of entries specifying available interaction types and/or how to access answerers that support such interaction types (e.g., an entry for a video call interaction type may list email addresses, hyperlinks to websites, links to applications, and/or other manners for identifying and/or accessing an answerer that can support video calls for answering questions; an entry for a forum interaction type may list known forums through which questions may be posed; etc.). The interaction type may comprise a real time chat between the requester user and an answerer user, an offline messaging answer service (e.g., a onetime text message answer), a screen sharing between the requester user and the answerer user, a phone call between the requester user and the answerer user, a video call between the requester user and the answerer user, a public forum, a private forum, a social network post, a helpdesk type service (e.g., a real time interactive chat sessions between the requester user and the answerer user), a question and answer service, a human search engine search (e.g., a paid expert searcher that may perform internet searches to obtain informational answers), access to multimedia content, access to a document, access to a website, access to content provided by a content provider, access to textual content, access to audio content, access to visual content, etc. For example, a public forum may be selected as the interaction type for the question “what is the best pizza in Cleveland”.

At 110, an answerer pool is selected based upon the information request property. In an example, the answerer pool is selected from an answerer pool catalogue that may comprise a database, a table, a list, etc. of entries specifying available answers and/or how to access such answerers (e.g., an email address of an answerer, a hyperlink to a question and answer forum, a link to a chat application through which a user may engage in a question and answer session, a phone number of an answerer, a link to a content provider or service that may provide answers, etc.). The answerer pool may comprise a paid answerer, an unpaid answerer, social network entities/friends, a forum user, a topic expert that specified a first knowledge level in a topic of the information request above an expert threshold, a non-topic expert that specified a second knowledge level in the topic below the expert threshold, an internet search expert that specified a search expertise above a search expert threshold, a custom defined answerer pool of answerers (e.g., particular users identified as potential answerers of the information question), a content provider (e.g., a food information provider), a website (e.g., a pizza review website), a document (e.g., a pizza rating article), multimedia content (e.g., a restaurant review video), an artificial intelligence answerer, a personal assistant program, a machine answerer, a user that previously submitted a previous information request corresponding to the topic, etc.

Various other information may be used to identify the interaction type and/or the answerer pool. In an example, a property-independent input associated with the information request may be identified (e.g., historical question data for one or more previous submissions of the information request, a success rate for a previous answer scheme provided for the information request, a freshness of the information request with respect to the user, etc.). The interaction type and/or the answerer pool may be selected based upon the property-independent input. In an example, a previous manual selection of a manually selected answerer pool for the information request and/or a prior information request having a similarity to the information request above a threshold may be identified (e.g., a previous user may have submitted the same or a similar information request and may have manually selected an answerer pool to use). The answerer pool may be selected based upon the manually selected answerer pool. In an example, a previous manual selection of a manually selected interaction type for the information request may be identified (e.g., a previous user may have submitted the information request and may have manually selected an interaction type to use). The interaction type may be selected based upon the manually selected interaction type. In an example, a user rating for an information answer outcome associated with a previous informational answer of a previous submission of the information request may be identified (e.g., a previous user may have specified a low rating for a helpdesk interaction type that was suggested when the previous user asked about what is the best food in a particular location). The user rating may comprise an answer pool user rating for an answerer pool and/or an interaction type user rating for an interaction type. The interaction type and/or the answerer pool may be selected based upon the user rating (e.g., the helpdesk interaction type may be disqualified as the interaction type).

At 112, an answer scheme, to use for obtaining the informational answer, may be provided. The answer scheme may comprise the interaction type and/or the answerer pool (e.g., a suggestion of an interaction service corresponding to the interaction type and the answerer pool). For example, a public food lovers forum may be suggested through the answer scheme for obtaining an answer to the information request “what is the best pizza in Cleveland”. In an example, a set of interaction types, corresponding to the information request property, may be ranked to create a ranked set of interaction types. A set of answerer pools, corresponding to the information request property, may be ranked to create a ranked set of answerer pools. The ranked set of interaction types and/or the ranked set of answerer pools may be included within the answer scheme. In this way, the user may select a desired interaction type and/or answerer pool.

In an example, the information request may be submitted to an interaction service corresponding to the interaction type and the answerer pool. For example, the information request “what is the best pizza in Cleveland” may be submitted to the public food lovers forum. The requester user may be provided with informational answer tracking functionality for the interaction service. In this way, the requester user may track the submission of the information request “what is the best pizza in Cleveland” to determine whether the informational answer was provided (e.g., a link to the public food lovers forum; an email or text message alert regarding an update to the public food lovers forum; the creation of an operating system tile or other tracking interface that is linked to the public food lovers forum; etc.).

In an example, a user rating interface may be provided to the requester user based upon the answer scheme. The user rating interface may comprise an answerer pool user rating interface through which the user may specify an answer pool user rating. The user rating interface may comprise an interaction type user rating interface through which the user may specify an interaction type user rating. A user rating for at least one of the interaction type or the answerer pool may be received through the user rating interface. The user rating may be utilized for subsequent evaluation of the information request (e.g., the user rating may be taken into consideration for selecting a new interaction type and/or a new answerer pool for a subsequent requester user that submits the information request).

In an example, the requester user may manually override the answer scheme. For example, a user manual override scheme for the answer scheme may be received. The user manual override scheme may comprise a manually selected interaction type and/or a manually selected answerer pool (e.g., an instruction to create a social network post “what is the best pizza in Cleveland” for evaluation by social network friends of the requester user). The information request may be submitted to an interaction service associated with the user manual override scheme. At 114, the method ends.

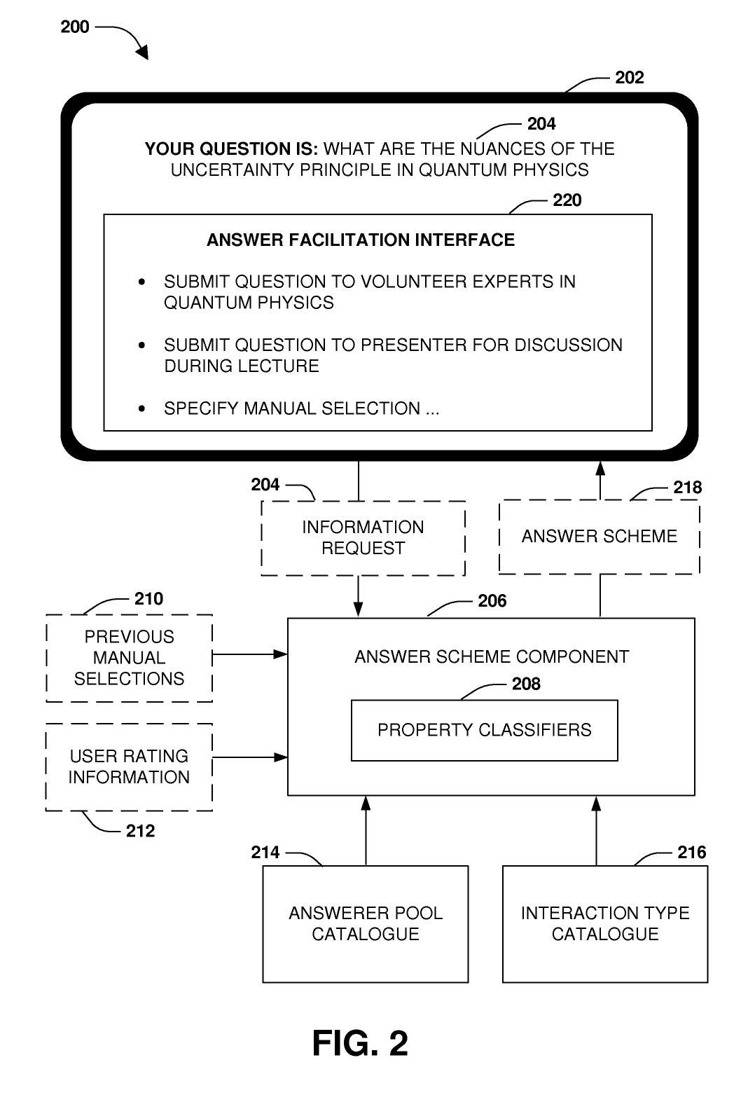

FIG. 2 illustrates an example of a system 200 for providing an answer scheme for an information request. The system 200 comprises an answer scheme component 206. The answer scheme component 206 may be associated with a computing device 202. The answer scheme component 206 may receive an information request 204 from the computing device 202. For example, the information request 204 may correspond to a user question of “what are the nuances of the uncertainty principle in quantum physics” (e.g., the user question may have been posed to a personal assistant application of the computing device 202).

The answer scheme component 206 may utilize one or more property classifiers 208 to evaluate the information request 204 in order to determine a value of an information request property of the information request 204. A property classifier 208 may identify a domain/area of the information request 204. For example, an interestingness property classifier may classify the information request 204 with an information request property that may be used to determine, for example, that the information request 204 would be interesting to physics topic experts, but uninteresting to non-science topic experts. An expertise level property classifier may specify, through the information request property, that the information request 204 has a relatively high expertise level. In this way, the property classifiers 208 may specify various properties through the information request property, such as that the information request 204 is not urgent and is not sensitive, that the information request 204 is an open question seeking opinions, etc.

The answer scheme component 206 may select an answerer pool from an answerer pool catalogue 214 and an interaction type from an interaction type catalogue 216 based upon the information request property. In an example, the answer scheme component 206 may utilize previous manual selection data 210 (e.g., a previous manual selection of a manually selected answer pool and/or a manually selected interaction type by a user that previously submitted that information request 204 or a variation thereof such as “what are the particulars of quantum physics”) for selecting the answerer pool and/or the interaction type. In an example, the answer scheme component 206 may utilize user rating information 212 (e.g., a user rating for an information answer outcome associated with a previous informational answer of a previous submission of the information request 204 or a variation thereof such as “what is everyone's opinion on the uncertainty principle”) for selecting the answerer pool and/or the interaction type. In an example, the answer scheme component 206 may utilize a property-independent input associated with the information request 204 for selecting the answerer pool and/or the interaction type (e.g., an aspect of an information request about which a property has not been ascertained). In an example, the answer scheme component 206 may dynamically determine the answerer pool and/or the interaction type, which may not (e.g., initially) be comprised within the answerer pool catalogue 214 and/or the interaction type catalogue 216. For example, the answer scheme component 206 may perform a search of websites, forums, social networks, applications, services, etc. using the information request property to dynamically determine the answerer pool and/or the interaction type. If a new answerer pool and/or a new interaction type is discovered, then the new answerer pool and/or the new interaction type may be added into the answerer pool catalogue 214 and/or the interaction type catalogue 216.

In an example, the interaction type and/or the answerer pool may be selected based upon a user property of the requester user. For example, user information of the requester user may be identified. The user information may correspond to a user profile (e.g., the requester user may indicate that the user is an information technology (IT) professional), social network data (e.g., the requester user may post a social network post “I am excited for the new Fire Router”), email data (e.g., the requester user may receive computer hardware newsletters), message data, calendar data (e.g., a calendar entry of a networking computer class on Wednesday), web browsing history (e.g., the requester user may visit various technology websites), purchase history (e.g., the requester user may purchase oscilloscopes, networking hardware, robot kits, etc.), a forum post (e.g., the requester user may frequently visit electronic forums), a previous question submitted by the requester user, a previous answer provided by the requester user, content accessed by the requester user (e.g., the requester user may create and share networking applications written by the requester user), an application installed on a user device of the requester user, an expertise level specified by the requester user, a user demographic (e.g., age, occupation, gender, etc.), and/or a variety of other information for which the user has provided expressed or implied consent to use for the creation of answer schemes. The user information may be evaluated to identify the user property of the requester user. In an example, an expert answerer pool of an IT forum may be selected based upon the user property indicating that the requester user has a relatively high level of expertise in a subject matter of the information request, such as a networking question. In this manner, an informational answer provided to the requester user may be more likely to be commensurate with a competency of the requester user (e.g., not too advanced, not overly simplified, etc.), and thus beneficial, valuable, etc. to the requester user.

The answer scheme component 206 may create an answer scheme 218 based upon the answerer pool and/or the interaction type. For example, the answer scheme 218 may provide a first recommendation for submitting the information request 204 to volunteer experts in quantum physics, a second recommendation for submitting the information request 204 to a presenter for discussion during a lecture such as via a whiteboard, and/or other recommendations not illustrated. The answer scheme 218 may be displayed through an answer facilitation interface 220 through which the requester user may access an interaction service for submission of the information request 204. The answer scheme 218 may allow the user to manually select or specify a manually selected answerer pool and/or a manually selected interaction type for use in obtaining an informational answer to the information request.

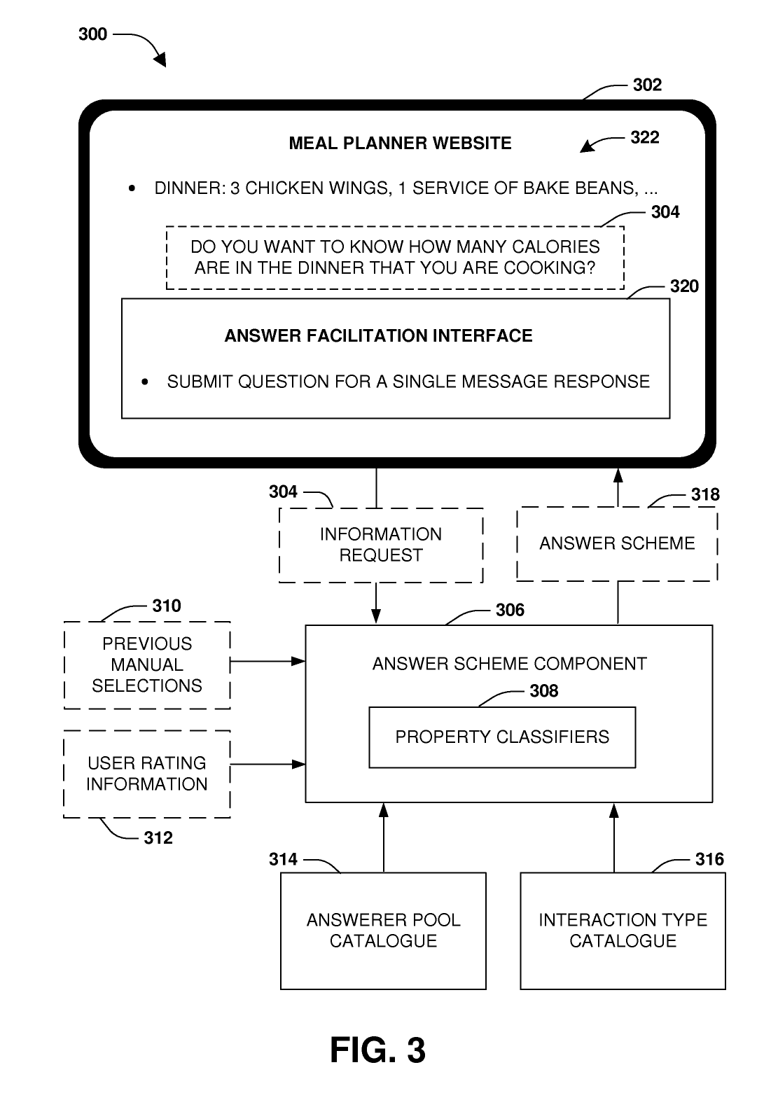

FIG. 3 illustrates an example of a system 300 for providing an answer scheme for an information request. The system 300 comprises an answer scheme component 306. The answer scheme component 306 may be associated with a computing device 302. The answer scheme component 306 may receive an information request 304 from the computing device 302. For example, the information request 304 may correspond to a dinner plan that a requester user may be planning through a meal planner website 322. The meal planner website 322 may provide a suggestion of the information request 304, such as an inquiry into how many calories are in the dinner that the requester user is planning.

The answer scheme component 306 may utilize one or more property classifiers 308 to evaluate the information request 304 in order to determine an information request property of the information request 304. For example, an interestingness property classifier may classify the information request 304 with an information request property that may be used to determine, for example, that the information request 304 would not be interesting to unpaid answerers and thus paid answerers may be better suited for answering the information request 304 compared to unpaid answerers that may merely desire to answer questions that are interesting. An expertise level property classifier may specify, through the information request property, that the information request 304 has a relatively low expertise level. In this way, the property classifiers 308 may specify various properties through the information request property, such as that the information request 304 is somewhat urgent (e.g., since the requester user might be starting to cook in 4 hours), that the information request 304 is a factual question, etc.

The answer scheme component 306 may select an answerer pool from an answerer pool catalogue 314 and an interaction type from an interaction type catalogue 316 based upon the information request property. In an example, the answer scheme component 306 may utilize previous manual selection data 310, user rating information 312 (e.g., answerer pool user ratings and/or interaction type user ratings), and/or property-independent input for selecting the answerer pool and/or the interaction type (e.g., a user may have specified a relatively high rating for a single message response interaction type for a similar cooking question). In an example, the answer scheme component 306 may identify correlations between answerer pools and interaction types. For example, the answer scheme component 306 may assign a relatively higher correlation between a human answerer and a phone call interaction type than between a machine answerer and the phone call interaction type. In another example, the answer scheme component 306 may assign a relatively higher correlation between a community of answerers and a forum interaction type than between the community of answerers and a phone call interaction type.

The answer scheme component 306 may create an answer scheme 318 based upon the answerer pool and/or the interaction type. For example, the answer scheme 318 may provide a recommendation for submitting the information request 304 through a single message response interaction service that may provide a onetime text message answer by a paid answerer for the information request 304. The answer scheme 318 may be displayed through an answer facilitation interface 320 through which the requester user may access an interaction service for submission of the information request 304 (e.g., and through which an informational answer to the information request may resultantly be presented to the requester user).

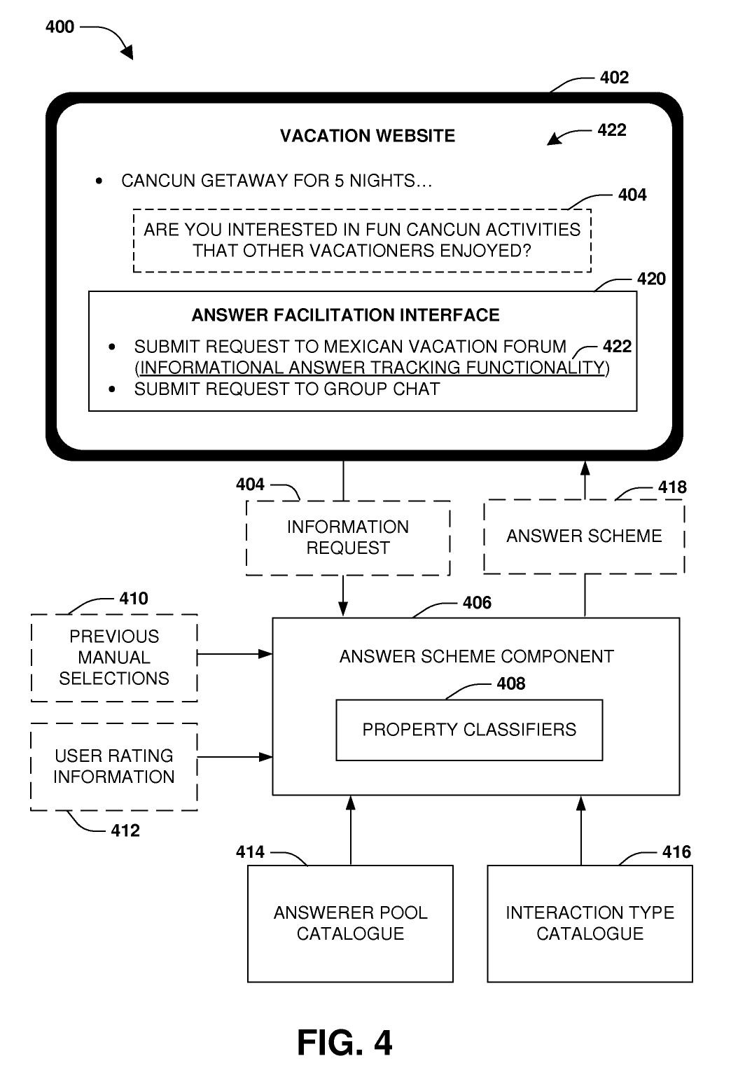

FIG. 4 illustrates an example of a system 400 for providing an answer scheme for an information request. The system 400 comprises an answer scheme component 406. The answer scheme component 406 may be associated with a computing device 402. The answer scheme component 406 may receive an information request 404 from the computing device 402. For example, the information request 404 may correspond to a suggestion for a vacation plan suggested through a vacation website 422. The suggestion may, for example, correspond to an inquiry into fun Cancun activities that other vacationers enjoyed.

The answer scheme component 406 may utilize one or more property classifiers 408 to evaluate the information request 404 in order to determine an information request property of the information request 404. For example, an interestingness property classifier may classify the information request 404 with an information request property that may be used to determine, for example, that the information request 404 would be interesting to non-paid answerers that have visited Cancun. An expertise level property classifier may specify, through the information request property, that the information request 404 has a relatively low expertise level. A topic property classifier may specify, through the information request property, that the information request 404 corresponds to a vacation topic. In this way, the property classifiers 408 may specify various properties through the information request property, such as that the information request 404 is not urgent (e.g., the Cancun vacation may be 6 months away), that the information request 404 is an open question seeking opinions from vacationers that have visited Cancun, etc.

The answer scheme component 406 may select an answerer pool from an answerer pool catalogue 414 and an interaction type from an interaction type catalogue 416 based upon the information request property. In an example, the answer scheme component 406 may utilize previous manual selection data 410, user rating information 412 (e.g., answerer pool user ratings and/or interaction type user ratings), and/or property-independent input for selecting the answerer pool and/or the interaction type (e.g., a first user may have manually selected a group chat interaction type and a second user may have manually selected a vacation forum interaction type).

The answer scheme component 406 may create an answer scheme 418 based upon the answerer pool and/or the interaction type. For example, the answer scheme 418 may provide a first recommendation for submitting the information request 404 through a Mexican vacation forum. Information answer tracking functionality 422 may be provided for the Mexican vacation forum so that the requester user may track the submission of the information request 404 to see whether an informational answer has been provided through the Mexican vacation forum. The answer scheme 418 may provide a second recommendation for submitting the information request 404 to a group chat of vacationers. In an example, the answer scheme 418 may provide an ordered series of recommendations. For example, an instant message answering technique may be recommended first. If a desired answer is not obtained from the instant message answering technique, then a distribution list may be recommended. If a desired answer is not obtained from answerers on the distribution list, then a forum of paid answerers may be recommended. The recommendations may be ordered based upon various criteria such as costs incurred (e.g., obtaining a free answer may be preferred over paying for an answer), an answer quality (e.g., a forum of expert answerers may be preferred over a social network post to novice answerers such as social network friends of the requester user), a speed of receiving an answer, a user preference (e.g., the user may prefer a text message, but rather not receive a phone call), and/or a variety of other criteria. By posing the question in an ordered sequence, a desired answer may be more likely to be provided to the requester user in a manner that is amenable to the requester user.

The answer scheme 418 may be displayed through an answer facilitation interface 420 through which the requester user may access an interaction service for submission of the information request 404 (e.g., and through which an informational answer to the information request may resultantly be presented to the requester user).

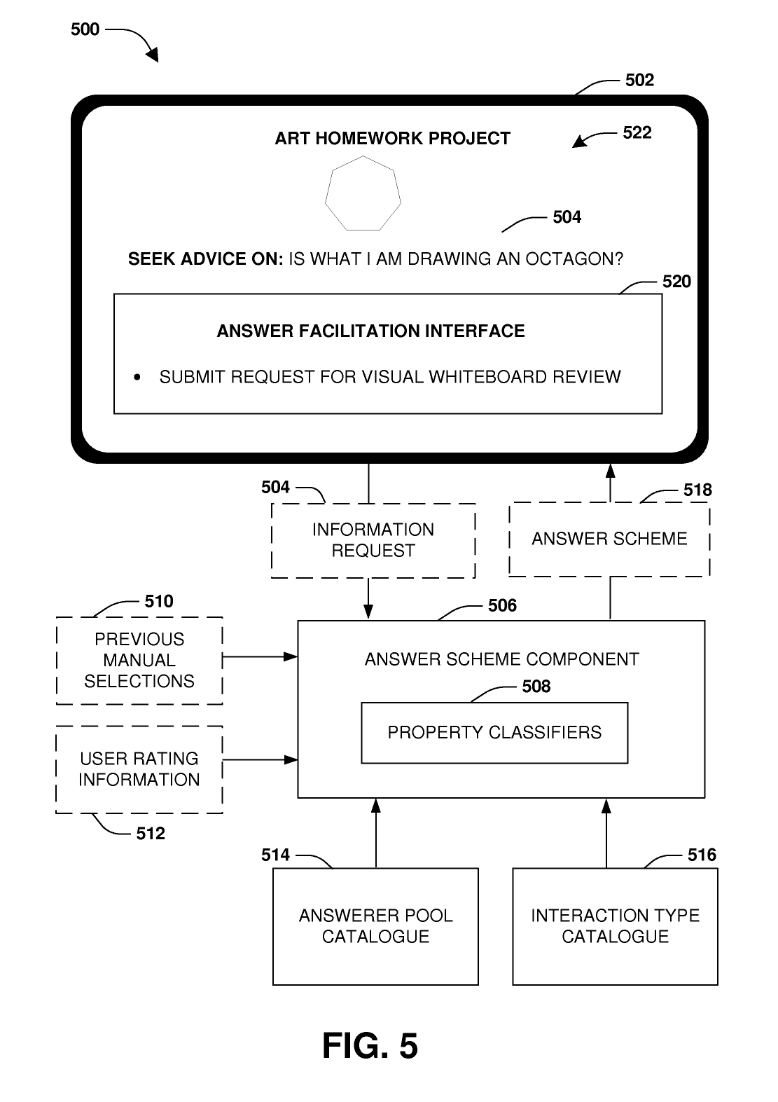

FIG. 5 illustrates an example of a system 500 for providing an answer scheme for an information request. The system 500 comprises an answer scheme component 506. The answer scheme component 506 may be associated with a computing device 502. The answer scheme component 506 may receive an information request 504 from the computing device 502. For example, the information request 504 may correspond to suggestion regarding an art homework project 522 being completed online through an educational website. The suggestion may, for example, correspond to a question as to whether a drawing is an octagon.

The answer scheme component 506 may utilize one or more property classifiers 508 to evaluate the information request 504 in order to determine an information request property of the information request 504. For example, an interestingness property classifier may classify the information request 504 with an information request property that may be used to determine, for example, that the information request 504 would not be interesting to unpaid answerers because the information request 504 corresponds to a rudimentary homework question. An expertise level property classifier may specify, through the information request property, that the information request 504 has a relatively low expertise level. A topic property classifier may specify, through the information request property, that the information request 504 corresponds to an art homework topic. In this way, the property classifiers 508 may specify various properties through the information request property, such as a visual property indicating that an answerer of the information request 504 may benefit from an image or video depicting the art homework project 522.

The answer scheme component 506 may select an answerer pool from an answerer pool catalogue 514 and an interaction type from an interaction type catalogue 516 based upon the information request property. In an example, the answer scheme component 506 may utilize previous manual selection data 510, user rating information 512 (e.g., answerer pool user ratings and/or interaction type user ratings), and/or property-independent input for selecting the answerer pool and/or the interaction type (e.g., the requester user may have a whiteboard account setup through a school).

The answer scheme component 506 may create an answer scheme 518 based upon the answerer pool and/or the interaction type. For example, the answer scheme 518 may provide a recommendation for submitting the information request 504 to a visual whiteboard for review, such as through the whiteboard account setup through the school. The answer scheme 518 may be displayed through an answer facilitation interface 520 through which the requester user may access an interaction service for submission of the information request 504 (e.g., and through which an informational answer to the information request may resultantly be presented to the requester user).

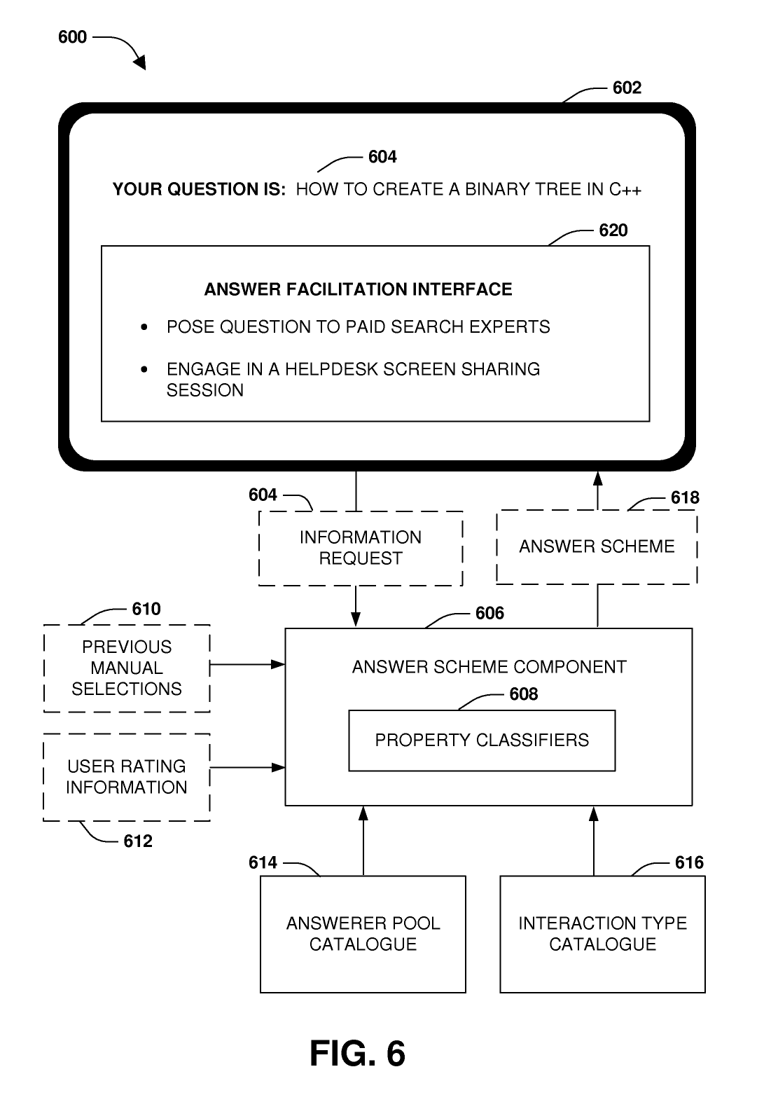

FIG. 6 illustrates an example of a system 600 for providing an answer scheme for an information request. The system 600 comprises an answer scheme component 606. The answer scheme component 606 may be associated with a computing device 602. The answer scheme component 606 may receive an information request 604 from the computing device 602. For example, the information request 604 may correspond to a question regarding how to create a binary tree in C++.

The answer scheme component 606 may utilize one or more property classifiers 608 to evaluate the information request 604 in order to determine an information request property of the information request 604. For example, an interestingness property classifier may classify the information request 604 with an information request property that may be used to determine, for example, that the information request 604 would not be interesting to an unpaid answerer. An expertise level property classifier may specify, through the information request property, that the information request 604 has a relatively high expertise level. A topic property classifier may specify, through the information request property, that the information request 604 corresponds to a programming topic. In this way, the property classifiers 608 may specify various properties through the information request property, such as a technology property.

The answer scheme component 606 may select an answerer pool from an answerer pool catalogue 614 and an interaction type from an interaction type catalogue 616 based upon the information request property. In an example, the answer scheme component 606 may utilize previous manual selection data 610, user rating information 612 (e.g., answerer pool user ratings and/or interaction type user ratings), and/or property-independent input for selecting the answerer pool and/or the interaction type (e.g., an employer of the requester user may have a helpdesk account).

The answer scheme component 606 may create an answer scheme 618 based upon the answerer pool and/or the interaction type. For example, the answer scheme 618 may provide a first recommendation for submitting the information request 604 to paid search experts that may search for an informational answer (e.g., a C++ binary tree template available through a programming website) using various search engines. The answer scheme 618 may provide a second recommendation for submitting the information request 604 through a helpdesk screen sharing session (e.g., corresponding to the helpdesk account of the employer). The answer scheme 618 may be displayed through an answer facilitation interface 620 through which the requester user may access an interaction service for submission of the information request 604 (e.g., and through which an informational answer to the information request may resultantly be presented to the requester user).

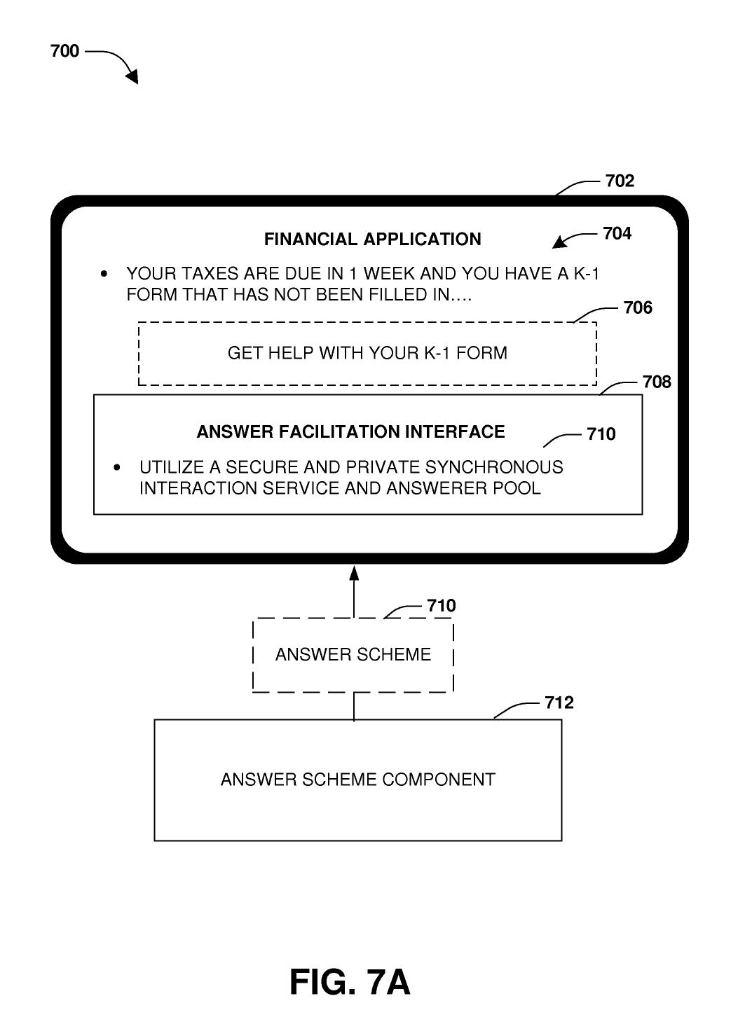

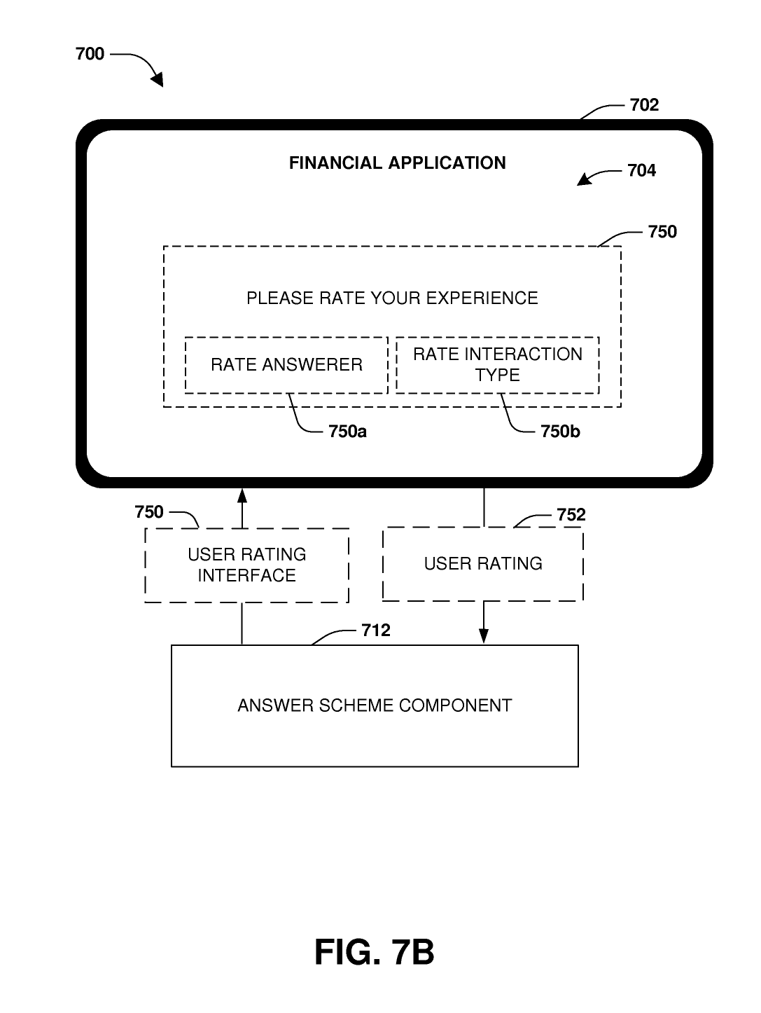

FIGS. 7A and 7B illustrate an example 700 of a requester user providing a user rating for an answer scheme 710 (e.g., answerer pool user ratings and/or interaction type user ratings). FIG. 7A illustrates a computing device 702 hosting a financial application 704 indicating to the requester user that taxes are due in 1 week and that the user has a K-1 form that has not yet been completed. The requester user may invoke a get help interface 706 for submitting an information request for getting help with the K-1 form. An answer scheme component 712 may generate and provide an answer scheme 710, comprising an interaction type and an answerer pool, through an answer facilitation interface 708 based upon the information request. For example, the answer scheme 710 may comprise a recommendation to submit the information request to a secure and private synchronous interaction service and answerer pool. The requester user may utilize the answer scheme 710 to obtain an informational answer to the information request.

FIG. 7B illustrates the answer scheme component 712 displaying a user rating interface 750 through the computing device 702. In an example, the user rating interface 750 may comprise an answerer pool user rating interface 750a and/or an interaction type user rating interface 750b. The user rating interface 750 may ask the requester user to provide a user rating 752 for the requester user's experience with attempting to obtain the informational answer using the answer scheme 710. The answer scheme component 712 may utilize the user rating 752 for subsequent submissions of the information request by users.

According to an aspect of the instant disclosure, a system for providing an answer scheme for an information request is provided. The system includes an answer scheme component. The answer scheme component is configured to receive an information request seeking an informational answer. The answer scheme component is configured to evaluate the information request to identify an information request property. The answer scheme component is configured to rank a set of interaction types based upon the information request property to create a ranked set of interaction types. The answer scheme component is configured to rank a set of answerer pools based upon the information request property to create a ranked set of answerer pools. The answer scheme component is configured to select an interaction type from the ranked set of interaction types based upon a first rank of the interaction type. The answer scheme component is configured to select an answerer pool from the ranked set of answerer pools based upon a second rank of the answerer pool. The answer scheme component is configured to provide an answer scheme to use for obtaining the informational answer. The answer scheme comprises the interaction type and the answerer pool.

According to an aspect of the instant disclosure, a method for providing an answer scheme for an information request is provided. The method includes receiving an information request seeking an informational answer. The method includes evaluating the information request to identify an information request property. The method includes selecting an interaction type based upon the information request property. The method includes selecting an answerer pool based upon the information request property. The method includes providing an answer scheme to use for obtaining the informational answer. The answer scheme comprises the interaction type and the answerer pool.

According to an aspect of the instant disclosure, a computer readable medium comprising instructions which when executed performs a method for providing an answer scheme for an information request is provided. The method includes receiving an information request seeking an informational answer. The method includes evaluating the information request to identify an information request property. The method includes selecting an interaction type based upon the information request property. The method includes selecting an answerer pool based upon the information request property. The method includes submitting the information request to an interaction service corresponding to the interaction type and the answerer pool. The method includes providing a requester user with informational answer tracking functionality for the interaction service.

According to an aspect of the instant disclosure, a means for providing an answer scheme for an information request is provided. An information request seeking an informational answer is received, by the means for providing an answer scheme. The information request is evaluated to identify an information request property, by the means for providing an answer scheme. A set of interaction types are ranked based upon the information request property to create a ranked set of interaction types, by the means for providing an answer scheme. A set of answerer pools are ranked based upon the information request property to create a ranked set of answerer pools, by the means for providing an answer scheme. An interaction type is selected from the ranked set of interaction types based upon a first rank of the interaction type, by the means for providing an answer scheme. An answerer pool is selected from the ranked set of answerer pools based upon a second rank of the answer pool, by the means for providing an answer scheme. An answer scheme to use for obtaining the informational answer is provided, by the means for providing an answer scheme. The answer scheme comprises the interaction type and the answerer pool.

According to an aspect of the instant disclosure, a means for providing an answer scheme for an information request is provided. An information request seeking an informational answer is received, by the means for providing an answer scheme. The information request is evaluated to identify an information request property, by the means for providing an answer scheme. An interaction type is selected based upon the information request property, by the means for providing an answer scheme. An answerer pool is selected based upon the information request property, by the means for providing an answer scheme. An answer scheme to use for obtaining the informational answer is provided, by the means for providing an answer scheme. The answer scheme comprises the interaction type and the answerer pool.

According to an aspect of the instant disclosure, a means for providing an answer scheme for an information request is provided. An information request seeking an informational answer is received, by the means for providing an answer scheme. The information request is evaluated to identify an information request property, by the means for providing an answer scheme. An interaction type is selected based upon the information request property, by the means for providing an answer scheme. An answerer pool is selected based upon the information request property, by the means for providing an answer scheme. The information request is submitted to an interaction service corresponding to the interaction type and the answerer pool, by the means for providing an answer scheme. A requester user is provided with informational answer tracking functionality for the interaction service, by the means for providing an answer scheme.

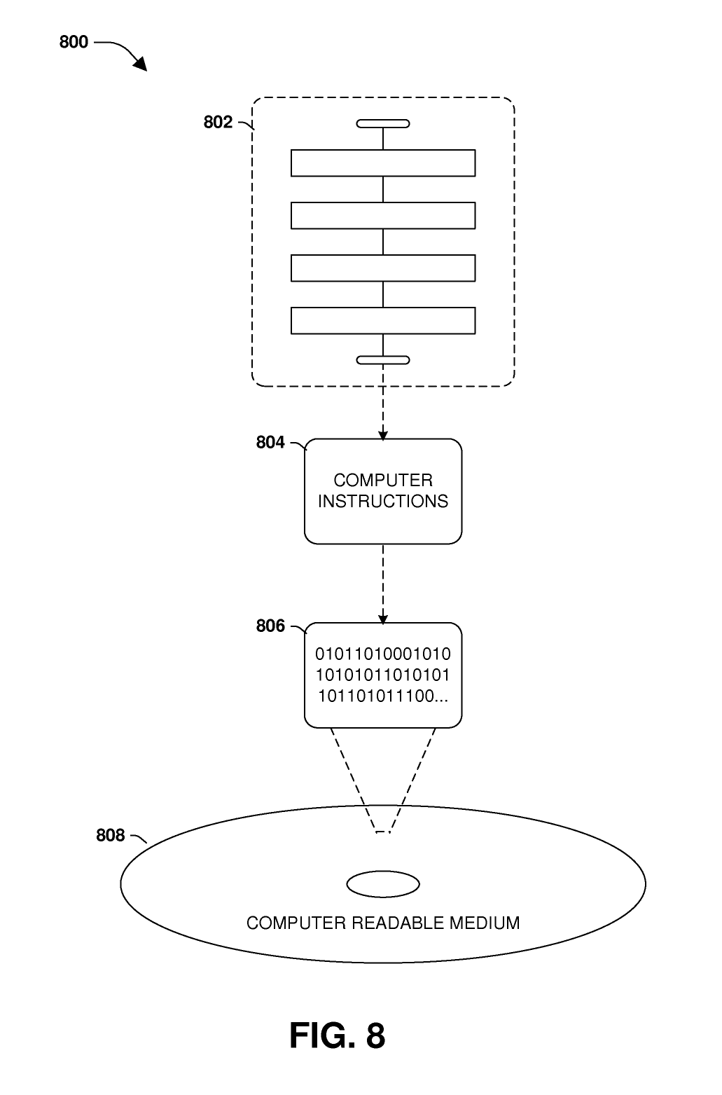

Still another embodiment involves a computer-readable medium comprising processor-executable instructions configured to implement one or more of the techniques presented herein. An example embodiment of a computer-readable medium or a computer-readable device is illustrated in FIG. 8, wherein the implementation 800 comprises a computer-readable medium 808, such as a CD-R, DVD-R, flash drive, a platter of a hard disk drive, etc., on which is encoded computer-readable data 806. This computer-readable data 806, such as binary data comprising at least one of a zero or a one, in turn comprises a set of computer instructions 804 configured to operate according to one or more of the principles set forth herein. In some embodiments, the processor-executable computer instructions 804 are configured to perform a method 802, such as at least some of the exemplary method 100 of FIG. 1, for example. In some embodiments, the processor-executable instructions 804 are configured to implement a system, such as at least some of the exemplary system 200 of FIG. 2, at least some of the exemplary system 300 of FIG. 3, at least some of the exemplary system 400 of FIG. 4, at least some of the exemplary system 500 of FIG. 5, and/or at least some of the exemplary system 600 of FIG. 6, for example. Many such computer-readable media are devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

As used in this application, the terms “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

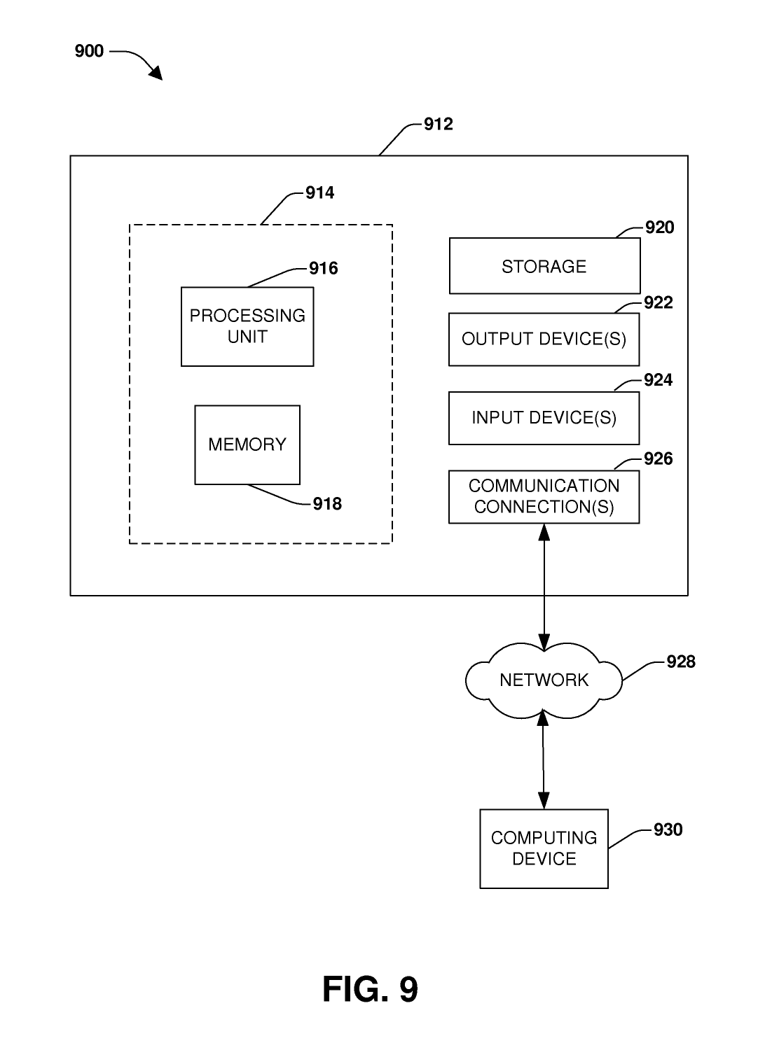

FIG. 9 and the following discussion provide a brief, general description of a suitable computing environment to implement embodiments of one or more of the provisions set forth herein. The operating environment of FIG. 9 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 9 illustrates an example of a system 900 comprising a computing device 912 configured to implement one or more embodiments provided herein. In one configuration, computing device 912 includes at least one processing unit 916 and memory 918. Depending on the exact configuration and type of computing device, memory 918 may be volatile (such as RAM, for example), non-volatile (such as ROM, flash memory, etc., for example) or some combination of the two. This configuration is illustrated in FIG. 9 by dashed line 914.

In other embodiments, device 912 may include additional features and/or functionality. For example, device 912 may also include additional storage (e.g., removable and/or non-removable) including, but not limited to, magnetic storage, optical storage, and the like. Such additional storage is illustrated in FIG. 9 by storage 920. In one embodiment, computer readable instructions to implement one or more embodiments provided herein may be in storage 920. Storage 920 may also store other computer readable instructions to implement an operating system, an application program, and the like. Computer readable instructions may be loaded in memory 918 for execution by processing unit 916, for example.

The term “computer readable media” as used herein includes computer storage media. Computer storage media includes volatile and nonvolatile, removable and non-removable media implemented in any method or technology for storage of information such as computer readable instructions or other data. Memory 918 and storage 920 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 912. Computer storage media does not, however, include propagated signals. Rather, computer storage media excludes propagated signals. Any such computer storage media may be part of device 912.

Device 912 may also include communication connection(s) 926 that allows device 912 to communicate with other devices. Communication connection(s) 926 may include, but is not limited to, a modem, a Network Interface Card (NIC), an integrated network interface, a radio frequency transmitter/receiver, an infrared port, a USB connection, or other interfaces for connecting computing device 912 to other computing devices. Communication connection(s) 926 may include a wired connection or a wireless connection. Communication connection(s) 926 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 912 may include input device(s) 924 such as keyboard, mouse, pen, voice input device, touch input device, infrared cameras, video input devices, and/or any other input device. Output device(s) 922 such as one or more displays, speakers, printers, and/or any other output device may also be included in device 912. Input device(s) 924 and output device(s) 922 may be connected to device 912 via a wired connection, wireless connection, or any combination thereof. In one embodiment, an input device or an output device from another computing device may be used as input device(s) 924 or output device(s) 922 for computing device 912.

Components of computing device 912 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 912 may be interconnected by a network. For example, memory 918 may be comprised of multiple physical memory units located in different physical locations interconnected by a network.

Those skilled in the art will realize that storage devices utilized to store computer readable instructions may be distributed across a network. For example, a computing device 930 accessible via a network 928 may store computer readable instructions to implement one or more embodiments provided herein. Computing device 912 may access computing device 930 and download a part or all of the computer readable instructions for execution. Alternatively, computing device 912 may download pieces of the computer readable instructions, as needed, or some instructions may be executed at computing device 912 and some at computing device 930.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Further, unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “exemplary” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B and/or both A and B. Furthermore, to the extent that “includes”, “having”, “has”, “with”, and/or variants thereof are used in either the detailed description or the claims, such terms are intended to be inclusive in a manner similar to the term “comprising”.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A system for providing an answer scheme for an information request, comprising:
an answer scheme component configured to:
receive an information request seeking an informational answer;
evaluate the information request to identify an information request property;
rank a set of interaction types based upon the information request property to create a ranked set of interaction types;
rank a set of answerer pools based upon the information request property to create a ranked set of answerer pools;
select an interaction type from the ranked set of interaction types based upon a first rank of the interaction type;
select an answerer pool from the ranked set of answerer pools based upon a second rank of the answer pool; and
provide an answer scheme to use for obtaining the informational answer, the answer scheme comprising the interaction type and the answerer pool.

2. The system of claim 1, the answer scheme component configured to:
identify a property-independent input associated with the information request, the property-independent input corresponding to at least one of historical question data for one or more previous submissions of the information request, a success rate for a previous answer scheme provided for the information request, or a freshness of the information request; and
responsive to identifying the property-independent input, select at least one of the interaction type or the answerer pool based upon the property-independent input.

3. The system of claim 1, the answer scheme component configured to:
identify at least one of a previous manual selection of a manually selected answerer pool for the information request or a previous manual selection of a manually selected interaction type for the information request; and
select at least one of the interaction type based upon the manually selected interaction type or the answerer pool based upon the manually selected answerer pool.

4. The system of claim 1, the answer scheme component configured to:
identify a user rating for an information answer outcome associated with a previous informational answer of a previous submission of the information request, the user rating comprising at least one of an answerer pool user rating or an interaction type user rating; and
select at least one of the interaction type or the answerer pool based upon the user rating.

5. The system of claim 1, the answer scheme component configured to:
provide an answer facilitation interface to a requester user that submitted the information request;
populate the answer facilitation interface with access to an interaction service corresponding to the interaction type and the answerer pool; and
populate the answer facilitation interface with access to a second interaction service corresponding to a second interaction type and a second answerer pool identified for inclusion within the answer scheme based upon the information request property.

6. A method for providing an answer scheme for an information request, comprising:
receiving an information request seeking an informational answer;
evaluating the information request to identify an information request property;
selecting an interaction type based upon the information request property;
selecting an answerer pool based upon the information request property; and
providing an answer scheme to use for obtaining the informational answer, the answer scheme comprising the interaction type and the answerer pool.

7. The method of claim 6, comprising:
identifying a property-independent input associated with the information request; and
selecting at least one of the interaction type or the answerer pool based upon the property-independent input.

8. The method of claim 6, comprising:
identifying a previous manual selection of a manually selected answerer pool for at least one of the information request or a prior information request having a similarity to the information request above a threshold; and
selecting the answerer pool based upon the manually selected answerer pool.

9. The method of claim 6, comprising:
identifying a previous manual selection of a manually selected interaction type for at least one of the information request or a prior information request having a similarity to the information request above a threshold; and
selecting the interaction type based upon the manually selected interaction type.

10. The method of claim 6, comprising:
identifying a user rating for an information answer outcome associated with a previous informational answer of a previous submission of the information request; and
selecting at least one of the interaction type or the answerer pool based upon the user rating.

11. The method of claim 6, the providing an answer scheme comprising:
submitting the information request to an interaction service corresponding to the interaction type and the answerer pool.

12. The method of claim 11, comprising:
providing a requester user with informational answer tracking functionality for the interaction service.

13. The method of claim 6, the information request comprising a question posed by a requester user.

14. The method of claim 6, the information request received from a requester user, and the method comprising:
evaluating user information of the requester user to identify a user property of the requester user, the user information comprising at least one of a user profile, social network data, email data, message data, calendar data, web browsing history, purchase history, a forum post, a user review for a product, a previous question submitted by the requester user, a previous answer provided by the requester user, content accessed by the requester user, an application installed on a user device of the requester user, an expertise level specified by the requester user, or a user demographic; and
selecting at least one of the interaction type or the answerer pool based upon the user property.

15. The method of claim 6, comprising:
receiving a user manual override scheme for the answer scheme, the user manual override scheme comprising at least one of a manually selected interaction type or a manually selected answerer pool; and
submitting the information request to an interaction service corresponding to the user manual override scheme.

16. The method of claim 6, the answerer pool comprising at least one of:
a paid answerer;
an unpaid answerer;
a social network entity;
a forum user;
a topic expert that specified a first knowledge level in a topic of the information request above an expert threshold;
a non-topic expert that specified a second knowledge level in the topic below the expert threshold;
an internet search expert that specified a search expertise above a search expert threshold;
a content provider;
a website;
a document;
multimedia content;
an artificial intelligence answerer;
a machine answerer;
a custom defined answerer pool of answerers; or
a user that previously submitted a previous information request corresponding to the topic.

17. The method of claim 6, the interaction type comprising at least one of:
a real time chat between a requester user and an answerer user;
an offline messaging answer service;
a screen sharing between the requester user and the answerer user;
a phone call between the requester user and the answerer user;
a video call between the requester user and the answerer user;
a public forum;
a private forum;
a social network post;
a helpdesk service;
access to multimedia content;
access to a document;
a website;
access to content provided by a content provider;
access to textual content;
access to audio content;
access to visual content;
a question and answer service; or
a human search engine service;

18. The method of claim 6, the information request property comprising:
a factual question property;
an interesting property;
an uninteresting property;
an open question seeking opinions property;
a sensitivity property;
an urgency property;
a technology property;
a homework property;
a visual property;
a previous unsuccessful attempt for an answer property;
a topic property; or
an expertise level property.

19. The method of claim 6, comprising:
ranking a set of interaction types corresponding to the information request property to create a ranked set of interaction types;
ranking a set of answerer pools corresponding to the information request property to create a ranked set of answerer pools; and
including the ranked set of interaction types and the ranked set of answerer pools within the answer scheme.

20. A computer readable medium comprising instructions which when executed perform a method for providing an answer scheme for an information request, comprising:
receiving an information request seeking an informational answer;
evaluating the information request to identify an information request property;
selecting an interaction type based upon the information request property;
selecting an answerer pool based upon the information request property;
submitting the information request to an interaction service corresponding to the interaction type and the answerer pool; and
providing a requester user with informational answer tracking functionality for the interaction service.
